(19) United States
(12) Patent Application Publication
(10) Pub. No.: US 2021/0108797 A1
(43) Pub. Date: Apr. 15, 2021

(54) Combustion Liner With Cooling Structure

(71) Applicant: Mitsubishi Power, Ltd., Yokohama-shi (JP)

(72) Inventors: Yasuhiro WADA, Yokohama-shi (JP); Shohei YOSHIDA, Yokohama-shi (JP); Akinori HAYASHI, Yokohama-shi (JP); Yoshitaka HIRATA, Yokohama-shi (JP); Hirokazu TAKAHASHI, Yokohama-shi (JP); Satoshi DODO, Yokohama-shi (JP); Shohei NUMATA, Yokohama-shi (JP); Tetsuma TATSUMI, Yokohama-shi (JP); Kazuki ABE, Tokyo (JP)

(21) Appl. No.: 17/070,087

(22) Filed: Oct. 14, 2020

(30) Foreign Application Priority Data
Oct. 15, 2019 (JP) 2019-188429

(51) Int. Cl. F23R 3/00; F23R 3/06; F02C 7/18

(52) U.S. Cl. CPC F23R 3/002; F23R 3/06; F23R 2900/03042; F23R 2900/00014; F02C 7/18

(57) ABSTRACT

The present invention provides a gas turbine combustor configured to form a film-like airflow around a region of a combustion liner, where pressure dynamics damping holes are formed for efficiently cooling the region where the pressure dynamics damping holes are formed without increasing concentration of discharged nitrogen oxides. The gas turbine combustor includes the combustion liner that forms a combustion chamber for receiving supply of fuel and air to generate combustion gas, a liner attached to an outer circumferential surface of the combustion liner for forming space from the outer circumferential surface, and the pressure dynamics damping hole formed in the combustion liner provided with the liner for communication between the space and the combustion chamber. The gas turbine combustor includes a cooling air guide lip disposed on an inner circumferential surface of the combustion liner for forming a film-like airflow around a region where the pressure dynamics damping hole is formed.

### CLAIM OF PRIORITY

The present application claims priority from Japanese Patent application serial no. 2019-188429, filed on Oct. 15, 2019, the content of which is hereby incorporated by reference into this application.

### BACKGROUND OF THE INVENTION

The present invention relates to a gas turbine combustor.

Gas turbine combustors of some type use liquefied natural gas as fuel. In this case, from an aspect of global environment conservation, a premix combustion mode for combustion of air-fuel premixture is employed to suppress quantity of generated nitrogen oxides (NOx) as a cause of air pollution.

In the premix combustion mode, the air-fuel premixture may suppress generation of locally high-temperature combustion region in combustion. It is therefore possible to suppress quantity of nitrogen oxides generated from the high-temperature combustion region.

Generally, the use of premix combustion mode succeeds in suppressing quantity of generated nitrogen oxides. However, in a certain case, the mode may fail to stabilize the combustion state, leading to pressure dynamics that causes periodical fluctuation of the pressure in the combustion chamber. Therefore, the premix combustion mode is combined with the diffusion combustion mode for stabilizing the combustion state excellently.

When using both the diffusion combustion mode and the premix combustion mode for suppressing quantity of generated nitrogen oxides, there may be the case that the proportion of the premix combustion to the diffusion combustion is increased, or the premix combustion is fully performed. In the above-described case, an acoustic liner is attached to an outer circumferential surface of the combustion liner constituting the combustion chamber for the purpose of attenuating the pressure fluctuation owing to the pressure dynamics.

The combustion liner provided with the acoustic liner has a plurality of pressure dynamics damping holes for attenuating the pressure fluctuation owing to the pressure dynamics. The acoustic liner has an air hole for supplying purge air to the inside of the acoustic liner to cool the combustion liner, and prevent flame from intruding into the acoustic liner.

An example of a background of the above-described technology includes WO2013/077394. The disclosed gas turbine combustor includes a combustion cylinder (combustion liner) and an acoustic liner attached to an outer circumferential surface of the combustion cylinder for forming space from the outer circumferential surface of the combustion cylinder. The combustion cylinder includes a group of through holes (pressure dynamics damping holes). The through holes are formed at intervals in a circumferential direction, and arranged in a plurality of rows at intervals in an axial direction.

### SUMMARY OF THE INVENTION

WO2013/077394 discloses the gas turbine combustor provided with the acoustic liner.

In WO2013/077394, however, there is no description on the gas turbine combustor configured to form a circumferentially continuous film-like air layer (airflow) around a region of the inner circumferential surface of the combustion liner, where the pressure dynamics damping holes are formed.

It is an object of the present invention to provide a gas turbine combustor configured to form a film-like airflow around a region of the combustion liner where the pressure dynamics damping holes are formed, and efficiently cool the region where the pressure dynamics damping holes are formed without increasing concentration of discharged nitrogen oxides.

The gas turbine combustor according to the present invention includes a combustion liner that forms a combustion chamber for receiving supply of fuel and air to generate combustion gas, a liner attached to an outer circumferential surface of the combustion liner for forming space from the outer circumferential surface, and a pressure dynamics damping hole formed in the combustion liner provided with the liner for communication between the space and the combustion chamber. The gas turbine combustor further includes a cooling air guide lip disposed on an inner circumferential surface of the combustion liner for forming a film-like airflow around a region where the pressure dynamics damping hole is formed.

The present invention provides a gas turbine combustor configured to form a film-like airflow around a region of the combustion liner, where the pressure dynamics damping holes are formed, and efficiently cool the region where the pressure dynamics damping holes are formed without increasing concentration of discharged nitrogen oxides.

Problems, structures, and advantageous effects other than those described above will be clarified by descriptions of the following examples.

### BRIEF DESCRIPTION OF THE DRAWINGS

FIG. 1 illustrates a schematic structure of a gas turbine plant to be described in a first example;

FIG. 2 illustrates a schematic partial structure of a gas turbine combustor 3 to be described in the first example;

FIG. 3 illustrates a schematic partial structure of a combustion liner 7 of the gas turbine combustor 3 to be described in the first example;

FIG. 4 illustrates a schematic partial structure of a combustion liner 7 of a gas turbine combustor 3 to be described in a second example;

FIG. 5 illustrates a schematic partial structure of a combustion liner 7 of a gas turbine combustor 3 to be described in a third example;

FIG. 6 illustrates a schematic partial structure of a combustion liner 7 of a gas turbine combustor 3 to be described in a fourth example;

FIG. 7 illustrates a schematic partial structure of a gas turbine combustor 3 to be described in a fifth example;

FIG. 8 illustrates a schematic partial structure of a gas turbine combustor 3 seen from a combustion chamber 8 to be described in the fifth example;

FIG. 9 is a sectional view of the gas turbine combustor 3 to be described in the fifth example, taken along line A-A of FIG. 7; and

FIG. 10 is a sectional view of the gas turbine combustor 3 to be described in the fifth example, taken along line B-B of FIG. 7.

### DETAILED DESCRIPTION OF THE PREFERRED EMBODIMENTS

Hereinafter, an explanation will be made with respect to examples according to the present invention with reference to the drawings. Substantially the same or similar structures will be designated with the same codes, and repetitive explanations thereof, thus, will be omitted.

### FIRST EXAMPLE

An explanation will be made with respect to a schematic structure of a gas turbine plant according to a first example.

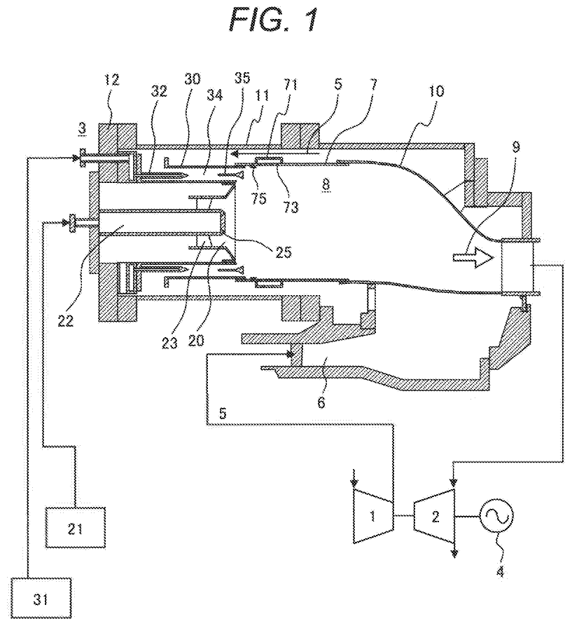

FIG. 1 illustrates the schematic structure of the gas turbine plant according to the first example.

The gas turbine plant according to the first example includes a turbine 2 driven by combustion gas 9, a compressor 1 connected to the turbine 2 for generating compressed air 5 for combustion (cooling), a plurality of gas turbine combustors 3 (hereinafter referred to as combustors) for generating the combustion gas 9 using fuel and the compressed air 5, and a generator 4 connected to the turbine 2 for generating power in association with operation of the turbine 2. FIG. 1 shows one unit of the combustor 3 for convenience of explanation.

The compressed air 5 discharged from the compressor 1 is supplied to the combustor 3 via a compressed air passage 6. In a combustion chamber 8 formed inside a combustion liner 7 for combustor (hereinafter referred to as combustion liner), the combustion gas 9 is generated by burning the compressed air 5 and the fuel. The combustion liner 7 is produced by forming a solid plate material into a roll-like shape. The combustion gas 9 is supplied to the turbine 2 for driving via a transition piece 10.

The combustor 3 includes a diffusion burner 20, a premix burner 30, the combustion liner 7, the transition piece 10, a casing 11 for combustor (hereinafter referred to as combustion casing), and an end cover 12. The diffusion burner 20 receives supply of diffusion fuel from a diffusion fuel supply system 21, and the premix burner 30 receives supply of premixed fuel from a premixed fuel supply system 31.

The diffusion burner 20 has a fuel jet hole 25 through which the diffusion fuel spouts via a fuel passage (fuel nozzle) 22. The diffusion burner 20 is provided with a swirler 23 for imparting a swirling component to air for combustion (compressed air 5).

The premix burner 30 is provided with a premixer 34 for mixing the premixed fuel spouting from a fuel passage (fuel nozzle) 32, and the air for combustion (compressed air 5). The premix burner 30 is provided with a flame stabilizer 35 in which the mixture of the premixed fuel and the compressed air 5 forms a premixed flame.

A liner 71 is attached to the outer circumferential surface of the combustion liner 7 (outer surface of the combustion liner 7 between the combustion liner 7 and the combustion casing 11), and forms space from the outer circumferential surface of the combustion liner 7. Pressure dynamics damping holes 73 are formed in the combustion liner 7 provided with the liner 71 for communication between the space and the combustion chamber 8.

A cooling air guide lip 75 for forming a film-like airflow is attached to the inner circumferential surface of the combustion liner 7 (inner surface of the combustion liner 7 at the side of the combustion chamber 8) around a region where the pressure dynamics damping holes 73 are formed.

The above-described structure ensures to form the film-like airflow around the region of the inner circumferential surface of the combustion liner 7, where the pressure dynamics damping holes 73 are formed. The region where the pressure dynamics damping holes 73 are formed may be efficiently cooled without increasing concentration of discharged nitrogen oxides.

An explanation will be made with respect to a schematic partial structure of the combustor 3 according to the first example.

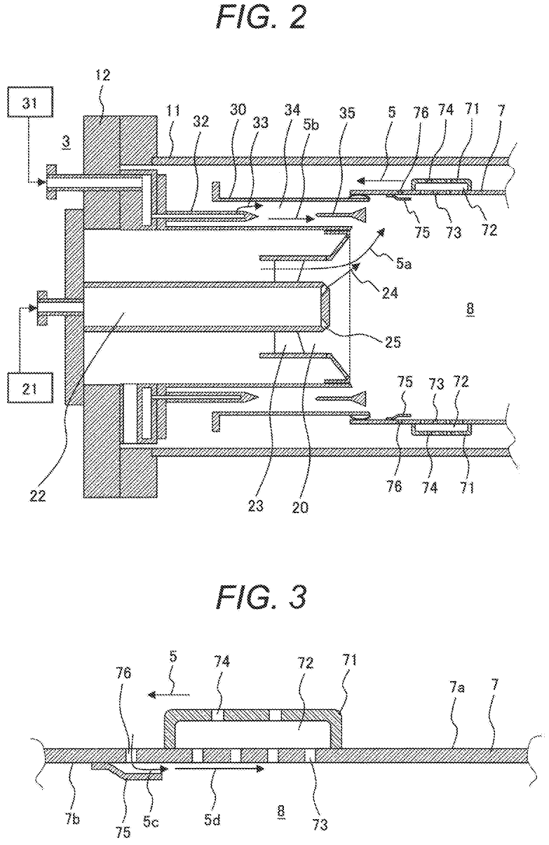

FIG. 2 illustrates a schematic partial structure of the combustor 3 according to the first example.

In the diffusion burner 20, diffusion fuel 24 circulating through the fuel passage (fuel nozzle) 22 spouts through the fuel jet hole 25. The swirling component is imparted to air 5a for combustion (compressed air 5) by the swirler 23 attached to the diffusion burner 20. The diffusion fuel 24 is mixed with the air 5a for combustion to generate diffusion flame downstream from the diffusion burner 20. In other words, the diffusion burner 20 supplies the air 5a for combustion and the diffusion fuel 24 to the combustion chamber 8.

The premix burner 30 allows the premixer 34 to mix premixed fuel 33 spouting through the fuel passage (fuel nozzle) 32 with air 5b for combustion (compressed air 5). The sufficiently mixed mixture of the premixed fuel 33 and the air 5b for combustion generates the premixed flame downstream from the flame stabilizer 35. In other words, the premix burner 30 is disposed at an outer circumferential side of the diffusion burner 20 for supplying the air 5b for combustion and the premixed fuel 33 to the combustion chamber 8.

As described above, the combustor 3 according to the first example includes the diffusion burner 20 and the premix burner 30. The diffusion burner 20 spouts the diffusion fuel 24 flowing through the fuel nozzle 22 to impart the swirling component to the air 5a for combustion so that the diffusion flame is generated. The premix burner 30 mixes the premixed fuel 33 spouting through the fuel nozzle 32 with the air 5b for combustion so that the premixed flame is generated.

Upon reception of thermal energy from the diffusion flame, the premixed flame stably burns in the combustion chamber 8 (suppressing generation of the locally high-temperature combustion region during burning). This makes it possible to suppress quantity of generated nitrogen oxides.

The outer circumferential surface of the combustion liner 7 is provided with the liner 71 for forming space 72 with the outer circumferential surface of the combustion liner 7. The combustion liner 7 provided with the liner 71 has the pressure dynamics damping holes 73 for communication between the space 72 and the combustion chamber 8. In other words, the pressure dynamics damping holes 73 are formed in the combustion liner 7 provided with the liner 71 for communication between the space 72 and the combustion chamber 8.

The liner 71 has air holes 74 through which the compressed air 5 is introduced as purge air into the space 72. The compressed air 5 (purge air) to be introduced through the air holes 74 cools the space 72 (liner 71) to prevent intrusion of the flame into the space 72.

The compressed air 5 introduced into the space 72 spouts into the combustion chamber 8 through the pressure dynamics damping holes 73 to cool the region where the pressure dynamics damping holes 73 are formed.

A plurality of pressure dynamics damping holes 73 are formed in rows along a circumferential direction of the combustion liner 7, and in a plurality of rows along an axial direction. Preferably, the pressure dynamics damping holes 73 in one of the rows, and those in the next row are formed in a zigzag arrangement.

Provision of the liner 71 and the pressure dynamics damping holes 73 are effective for attenuating the pressure fluctuation owing to the pressure dynamics.

The combustion liner 7 has a cooling hole 76 for introducing the compressed air 5 into the combustion chamber 8. The cooling hole 76 is positioned between the flame stabilizer 35 and the liner 71 relative to the axial direction of the combustion liner 7.

The cooling air guide lip 75 is attached to the inner circumferential surface of the combustion liner 7. The cooling air guide lip 75 serves to supply the compressed air 5 introduced through the cooling hole 76 into the region where the pressure dynamics damping holes 73 are formed along the inner circumferential surface of the combustion liner 7. In other words, the cooling air guide lip 75 serves to form the circumferentially continuous film-like airflow along the inner circumferential surface of the combustion liner 7 around the region where the pressure dynamics damping holes 73 are formed.

The compressed air 5 flowing through the cooling hole 76 is supplied to a gap formed between the cooling air guide lip 75 and the inner circumferential surface of the combustion liner 7, and deflects its flow to generate the film-like airflow along the inner circumferential surface of the combustion liner 7. This makes it possible to efficiently cool the region where the pressure dynamics damping holes 73 are formed without increasing the concentration of discharged nitrogen oxides.

An explanation will be made with respect to a schematic partial structure of the combustion liner 7 of the combustor 3 according to the first example.

FIG. 3 illustrates the schematic partial structure of the combustion liner 7 of the combustor 3 according to the first example.

The liner 71 is attached to an outer circumferential surface 7a of the combustion liner 7 to form the space 72 from the outer circumferential surface 7a of the combustion liner 7. The liner 71 with a substantially U-shaped cross-section continuously or nearly continuously surrounds the outer circumferential surface 7a of the combustion liner 7 circumferentially. The phrase “continuously surrounds” means that the liner 71 is continuous circumferentially. The phrase “nearly continuously surrounds” means that the liner 71 is partially discontinuous circumferentially.

The pressure dynamics damping holes 73 for communication between the space 72 and the combustion chamber 8 are formed in the combustion liner 7. The pressure dynamics damping holes 73 are formed in the circumferential and axial directions of the combustion liner 7 (the holes are formed in the row in the circumferential direction of the combustion liner 7, and the circumferential rows are arranged in the axial direction).

When the pressure dynamics occurs in the combustion chamber 8, the space 72 serves to suppress increase in amplitude of the pressure dynamics so that the pressure fluctuation owing to the pressure dynamics can be attenuated.

The air holes 74 for introducing the compressed air 5 into the space 72 are formed in the liner 71 in the circumferential and axial directions (formed in the row in the circumferential direction of the liner 71, and the circumferential rows are arranged in the axial direction). In other words, the air holes serve to introduce the compressed air 5 into the space 72 for cooling, and prevent intrusion of the flame into the space 72.

The compressed air 5 to be introduced into the space 72 spouts into the combustion chamber 8 through the pressure dynamics damping holes 73 for cooling the region where the pressure dynamics damping holes 73 are formed.

The pressure dynamics damping holes 73 serve to introduce pressure waves generated by the pressure dynamics into the space 72 (liner 71) for attenuating the pressure fluctuation owing to the pressure dynamics. The air hole 74 serves to introduce the compressed air 5 into the space 72 (liner 71) for cooling, and allows the compressed air 5 introduced into the space 72 to spout into the combustion chamber 8 through the pressure dynamics damping holes 73. As a result, the region where the pressure dynamics damping holes 73 are formed is cooled (metal temperature of the combustion liner 7 provided with the liner 71 is lowered).

The combustion liner 7 has the cooling hole 76 for introducing the compressed air 5 into the combustion chamber 8. The cooling hole 76 formed in the combustion liner 7 is positioned downstream from the liner 71 (left side of the liner 71 as shown in FIG. 3) relative to the flow direction of the compressed air 5 circulating between the combustion liner 7 and the combustion casing 11, that is, between the flame stabilizer 35 and the liner 71 relative to the axial direction of the combustion liner 7. The cooling holes 76 are formed in the combustion liner 7 in the circumferential direction.

An inner circumferential surface 7b of the combustion liner 7 is provided with the cooling air guide lip 75 for supplying the airflow 5c introduced through the cooling hole 76 to the region where the pressure dynamics damping holes 73 are formed along the inner circumferential surface 7b of the combustion liner 7. The cooling air guide lip 75 serves to form a circumferentially continuous film-like airflow 5d along the inner circumferential surface 7b of the combustion liner 7 around the region where the pressure dynamics damping holes 73 are formed. In other words, the cooling air guide lip 75 is disposed upstream from the pressure dynamics damping holes 73 relative to the flow direction of the film-like airflow 5d (downstream from the liner 71 relative to the flow direction of the compressed air 5).

The cooling air guide lip 75 deflects the airflow 5c introduced through the cooling hole 76 to form the film-like airflow 5d. The cooling air guide lip 75 disposed between the flame stabilizer 35 and the liner 71 relative to the axial direction of the combustion liner 7 is attached to continuously or nearly continuously surround the inner circumferential surface 7b of the combustion liner 7 circumferentially (radial direction).

The cooling air guide lip 75 is disposed at a position corresponding to the cooling hole 76. The cooling air guide lip 75 is attached to the inner circumferential surface 7b of the combustion liner 7 downstream from the liner 71 relative to the flow direction of the compressed air 5, and continuously or nearly continuously surrounds the inner circumferential surface 7b of the combustion liner 7 circumferentially. The cooling air guide lip extends along the axial direction of the combustion liner 7 to form the gap from the inner circumferential surface 7b of the combustion liner 7.

The cooling hole 76 is formed corresponding to the cooling air guide lip 75 so that the compressed air 5 is introduced into the gap formed between the cooling air guide lip 75 and the inner circumferential surface 7b of the combustion liner 7.

As a result, the airflow 5c introduced through the cooling hole 76 deflects its flow, and diffuses in the circumferential direction of the inner circumferential surface 7b of the combustion liner 7 so that the film-like airflow 5d is formed along the inner circumferential surface 7b of the combustion liner 7.

In the first example, the film-like airflow 5d formed around the region where the pressure dynamics damping holes 73 are formed may efficiently cool the region. In other words, the flow rate of the compressed air 5 spouting into the combustion chamber 8 through the pressure dynamics damping holes 73 may be reduced, and accordingly, the volume of the compressed air 5 to be introduced into the space 72 through the air holes 74 may be reduced. This makes it possible to prevent increase in the concentration of discharged nitrogen oxides, resulting in the lowered concentration.

In the first example, the film-like airflow 5d may be formed around the inner circumferential surface 7b of the combustion liner 7, corresponding to the liner 71 with a small air volume. This makes it possible to cool the region where the pressure dynamics damping holes 73 are formed with a small air volume. Generation of the locally high-temperature combustion region may be suppressed to lower the concentration of discharged nitrogen oxides.

In the first example, the flow rate of the compressed air 5 for cooling the region where the pressure dynamics damping holes 73 are formed may be reduced. In other words, the flow rate of air for combustion may be increased. This makes it possible to lower the concentration of discharged nitrogen oxides.

The combustor 3 according to the first example includes the combustion liner 7 that constitutes the combustion chamber 8 where the combustion gas 9 is generated using the fuel (for example, the diffusion fuel and the premixed fuel) and the compressed air 5, the liner 71 circumferentially attached to the outer circumferential surface 7a of the combustion liner 7 for circumferentially forming the space 72 from the outer circumferential surface 7a of the combustion liner 7, and the pressure dynamics damping holes 73 formed in the combustion liner 7 (provided with the liner 71) while facing the liner 71 that forms the space 72 for communication with the combustion chamber 8.

The liner 71 has the air holes 74 for introducing the compressed air 5 into the space 72 so that the compressed air 5 spouts into the combustion chamber 8 through the pressure dynamics damping holes 73.

The combustor 3 further includes the cooling air guide lip 75 attached to the inner circumferential surface 7b of the combustion liner 7 downstream from the liner 71 relative to the flow direction of the compressed air 5, and continuously or nearly continuously surrounds the inner circumferential surface 7b of the combustion liner 7 circumferentially. The cooling air guide lip 75 axially extends along the combustion liner 7 to form the gap from the inner circumferential surface of the combustion liner 7. The cooling air guide lip 75 serves to form the film-like airflow 5d around the region where the pressure dynamics damping holes 73 are formed.

The cooling hole 76 is formed at the position corresponding to the cooling air guide lip 75 in the combustion liner 7 provided with the cooling air guide lip 75 so that the compressed air 5 is introduced into the gap formed between the cooling air guide lip 75 and the inner circumferential surface 7b of the combustion liner 7.

According to the first example, the cooling air guide lip 75 deflects the flow of the compressed air 5 (airflow 5c) introduced through the cooling hole 76. The airflow 5c circumferentially diffuses in the gap formed between the cooling air guide lip 75 and the inner circumferential surface 7b of the combustion liner 7, and flows in the axial direction to form the film-like airflow 5d. In other words, the circumferentially continuous uniform film-like airflow 5d is formed upstream from the pressure dynamics damping holes 73 that are formed downstream from the cooling air guide lip 75 relative to the flow direction of the film-like airflow 5d.

The cooling air guide lip 75 serves to form the circumferentially continuous uniform film-like airflow 5d. The film-like airflow 5d flows along the inner circumferential surface 7b of the combustion liner 7. As the airflow 5d flows, the inner circumferential surface 7b of the combustion liner 7 is efficiently cooled as well as the region where the pressure dynamics damping holes 73 are formed.

This makes it possible to reduce the flow rate of the compressed air 5 spouting into the combustion chamber 8 through the pressure dynamics damping holes 73. In other words, the flow rate of the air for combustion may be increased while relatively lowering the fuel concentration. Generation of the locally high-temperature combustion region is suppressed to lower the concentration of discharged nitrogen oxides.

In the first example, the pressure dynamics damping holes 73 are formed at predetermined intervals in the circumferential and axial directions of the combustion liner 7. Provision of the cooling air guide lip 75 and the cooling hole 76 serves to form the film-like airflow 5d along the inner circumferential surface 7b of the combustion liner 7. Accordingly, each area corresponding to the respective intervals may be efficiently cooled.

In the first example, each of the pressure dynamics damping holes 73 is formed vertically to the axial direction of the combustion liner 7 for the purpose of effectively introducing the pressure wave caused by the pressure dynamics into the space 72, suppressing increase in amplitude of the pressure dynamics, and attenuating the pressure fluctuation owing to the pressure dynamics. In other words, the compressed air 5 spouts to the center of the combustion chamber 8 through the pressure dynamics damping holes 73.

This makes it possible to reduce manufacturing costs for forming the pressure dynamics damping holes 73 in the combustion liner 7, and effectively attenuate the pressure fluctuation owing to the pressure dynamics. The combustor 3 may maintain mechanical reliability of its structure. Provision of the cooling air guide lip 75 and the cooling hole 76 serves to form the film-like airflow 5d along the inner circumferential surface 7b of the combustion liner 7 so that the region where the pressure dynamics damping holes 73 are formed is efficiently cooled.

In the first example, provision of the cooling air guide lip 75 and the cooling hole 76 allows a thin solid plate material to be formed into the combustion liner 7. In other words, the film-like airflow 5d along the inner circumferential surface 7b of the combustion liner 7 eliminates the needs for forming a tilt inside the combustion liner 7.

In the first example, the combustion liner 7 is formed of the thin solid plate material. However, the material for forming the combustion liner 7 is not limited to the thin solid plate material.

As the flow rate of the compressed air 5 spouting into the combustion chamber 8 through the pressure dynamics damping holes 73 becomes higher, the flow rate of the air 5b for combustion, fed to the premix burner 30 is reduced, resulting in relatively increased fuel concentration. Accordingly, there is a possibility that the locally high-temperature combustion region is generated.

In the first example, the cooling air guide lip 75 and the cooling hole 76 are provided to form the film-like airflow 5d along the inner circumferential surface 7b of the combustion liner 7. This makes it possible to cool the region where the pressure dynamics damping holes 73 are formed without reducing the flow rate of the air 5b for combustion supplied to the premix burner 30.

In other words, the flow rate of the compressed air 5 spouting into the combustion chamber 8 through the pressure dynamics damping holes 73 is reduced, and the flow rate of the air 5b for combustion, supplied to the premix burner 30 may be increased. This makes it possible to relatively lower the fuel concentration. It is therefore possible to lower the concentration of discharged nitrogen oxides.

In the first example, provision of the cooling air guide lip 75 and the cooling hole 76 serves to form the film-like airflow 5d along the inner circumferential surface 7b of the combustion liner 7. This may prevent generation of the flame around the inner circumferential surface 7b of the combustion liner 7 as well as suppress intrusion of the flame into the space 72 through the pressure dynamics damping holes 73.

### SECOND EXAMPLE

An explanation will be made with respect to a schematic partial structure of the combustion liner 7 of the combustor 3 according to a second example.

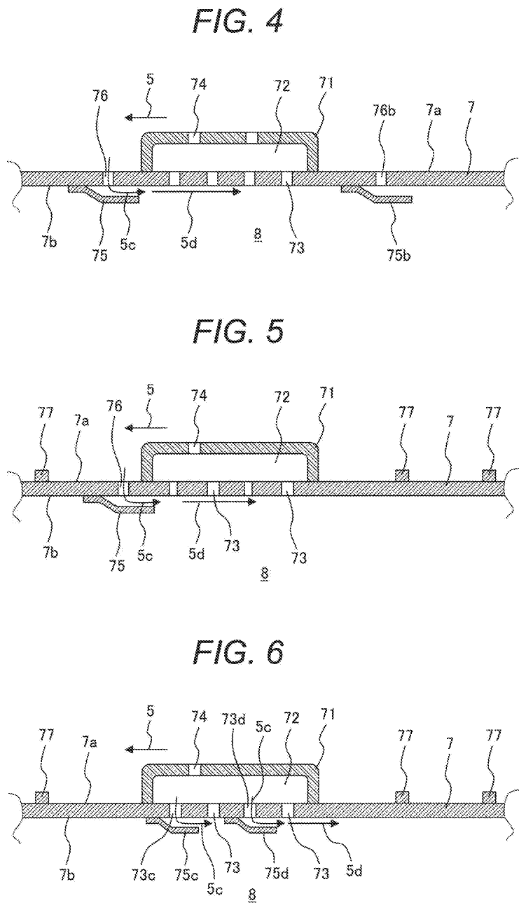

FIG. 4 illustrates a schematic partial structure of the combustion liner 7 of the combustor 3 according to the second example.

Compared with the combustor 3 according to the first example, the combustor 3 according to the second example is further provided with a cooling air guide lip 75b (second cooling air guide lip) and a cooling hole 76b (second cooling hole).

The cooling air guide lip 75b is attached to the inner circumferential surface 7b of the combustion liner 7 upstream from the liner 71 relative to the flow direction of the compressed air 5, and continuously or nearly continuously surrounds the inner circumferential surface 7b of the combustion liner 7 circumferentially. The cooling air guide lip axially extends along the combustion liner 7 to form the gap from the inner circumferential surface 7b of the combustion liner 7.

The cooling hole 76b is formed in the combustion liner 7 at a position corresponding to the cooling air guide lip 75b so that the compressed air 5 is introduced into the gap formed between the cooling air guide lip 75b and the inner circumferential surface 7b of the combustion liner 7.

In other words, the cooling hole 76b is formed in the combustion liner 7 upstream from the liner 71 for introducing the compressed air 5 into the combustion chamber 8. The cooling air guide lip 75b is attached at the position corresponding to the cooling hole 76b.

The film-like airflow 5d cools the region where the pressure dynamics damping holes 73 are formed. The airflow flowing between the cooling hole 76b and the cooling air guide lip 75b cools the part of the combustion liner downstream from the region where the pressure dynamics damping holes 73 are formed.

This makes it possible to efficiently cool the region where the pressure dynamics damping holes 73 are formed as well as the part downstream therefrom. Accordingly, the mechanical reliability of the structure of the combustor 3 may be maintained.

### THIRD EXAMPLE

An explanation will be made with respect to a schematic partial structure of the combustion liner 7 of the combustor 3 according to a third example.

FIG. 5 illustrates a schematic partial structure of the combustion liner 7 of the combustor 3 according to the third example.

Compared with the combustor 3 according to the first example, the combustor 3 according to the third example is further provided with a rib 77.

The rib 77 is continuously or nearly continuously surrounding the outer circumferential surface 7a of the combustion liner 7 circumferentially. The ribs 77 may be arranged in a plurality of rows in the axial direction of the combustion liner 7 or arranged in a single row.

The rib serves to convectively cool the outer circumferential surface 7a of the combustion liner 7. The flow rate of the compressed air 5 used for cooling may be reduced so that the outer circumferential surface 7a of the combustion liner 7 is convectively cooled. This makes it possible to suppress increase in the concentration of discharged nitrogen oxides.

In the third example, the ribs 77 are formed in two rows on the outer circumferential surface 7a of the combustion liner 7 upstream from the liner 71 relative to the flow direction of the compressed air 5, and in one row on the outer circumferential surface 7a of the combustion liner 7 downstream from the liner 71.

The ribs 77 disturb the flow of the compressed air 5 around those ribs 77. The resultant turbulence of the flow of the compressed air 5 enhances cooling effects.

In the third example, as the outer circumferential surface 7a of the combustion liner 7 is cooled by the air for combustion (compressed air 5), the flow rate of the air for combustion is not reduced. The flow rate of the compressed air for cooling may be reduced, and increase in the concentration of discharged nitrogen oxides may be suppressed.

In the third example, a plurality of air holes 74 are arranged in one circumferential row.

In the third example, the pressure dynamics damping holes 73 are arranged in the circumferential row which is formed into a plurality of axial rows. Each diameter of the pressure dynamics damping holes 73 in one of the rows is different from that of the pressure dynamics damping holes 73 formed in the next row.

The specification of the pressure dynamics damping hole 73 such as the diameter may influence an attenuation property for attenuating the pressure fluctuation owing to the pressure dynamics. Compared with the case where each of the pressure dynamics damping holes 73 has the same diameter, formation of the pressure dynamics damping holes 73 having different diameters from one another is expected to result in different attenuation properties.

### FOURTH EXAMPLE

An explanation will be made with respect to a schematic partial structure of the combustion liner 7 of the combustor 3 according to a fourth example.

FIG. 6 illustrates a schematic partial structure of the combustion liner 7 of the combustor 3 according to the fourth example.

The combustor 3 according to the fourth example has the cooling air guide lips 75 differently positioned from the cooling air guide lips 75 of the combustor 3 in the third example.

Specifically, the combustor 3 according to the fourth example has no cooling hole 76, and has the cooling air guide lips 75 positioned corresponding to the pressure dynamics damping holes 73. In the fourth example, a cooling air guide lip 75c (third cooling air guide lip) is attached to the position corresponding to the pressure dynamics damping hole 73c, and a cooling air guide lip 75d (fourth cooling air guide lip) is attached to the position corresponding to the pressure dynamics damping hole 73d.

The cooling air guide lips 75c and 75d are attached to the inner circumferential surface 7b of the combustion liner 7 provided with the liner 71 around the region where the pressure dynamics damping holes 73 are formed, and continuously surrounding the inner circumferential surface 7b of the combustion liner 7 circumferentially. Each cooling air guide lip extends in the axial direction of the combustion liner 7 so that the gap is formed from the inner circumferential surface 7b of the combustion liner 7.

In the fourth example, the cooling air guide lips 75c and 75d are attached to the inner circumferential surface 7b of the combustion liner 7 at the respective positions where the pressure dynamics damping holes 73c and 73d are formed except the pressure dynamics damping holes 73.

The pressure waves generated by the pressure dynamics intrude into the space 72 through the respective pressure dynamics damping holes 73, 73c, 73d. The space 72 serves to suppress increase in amplitude of the pressure dynamics for attenuating the pressure fluctuation owing to the pressure dynamics.

Each of the pressure dynamics damping holes 73 provides the effect for attenuating the pressure wave intruding through the corresponding hole. Meanwhile, each of the pressure dynamics damping holes 73c, 73d also provides the effect for attenuating the pressure wave intruding through the corresponding hole. The resultant attenuation effects derived from those holes, however, are considered to be different because of the cooling air guide lips 75c, 75d attached for covering the pressure dynamics damping holes 73c, 73d, respectively.

In the fourth example, the compressed air 5 introduced into the space 72 through the air hole 74 spouts as the airflow 5c into a gap formed between the cooling air guide lip 75c and the inner circumferential surface 7b of the combustion liner 7 through the pressure dynamics damping hole 73c, and into a gap formed between the cooling air guide lip 75d and the inner circumferential surface 7b of the combustion liner 7 through the pressure dynamics damping hole 73d.

The airflow 5c is deflected by the cooling air guide lips 75c, 75d to uniformly diffuse in the circumferential direction of the inner circumferential surface 7b of the combustion liner 7. The resultant airflow 5d flows along the inner circumferential surface 7b of the combustion liner 7.

In the fourth example, the inner circumferential surface 7b of the combustion liner 7 may be efficiently cooled with a small air volume. The flow rate of the compressed air 5 for cooling may be reduced, and increase in the concentration of discharged nitrogen oxides may be suppressed.

Especially in the fourth example, the use of the ribs 77 allows efficient cooling of the combustion liner 7 from both the outer circumferential surface 7a and the inner circumferential surface 7b of the combustion liner 7.

In the fourth example, two cooling air guide lips 75c, 75d are employed. However, one cooling air guide lip or three or more cooling air guide lips may be employed. Those cooling air guide lips may be combined with the cooling air guide lip 75.

The flow rate of the compressed air spouting through the pressure dynamics damping holes 73, 73c, 73d may be regulated by adjusting the air hole 74.

### FIFTH EXAMPLE

An explanation will be made with respect to a schematic partial structure of a combustor 3 according to a fifth example.

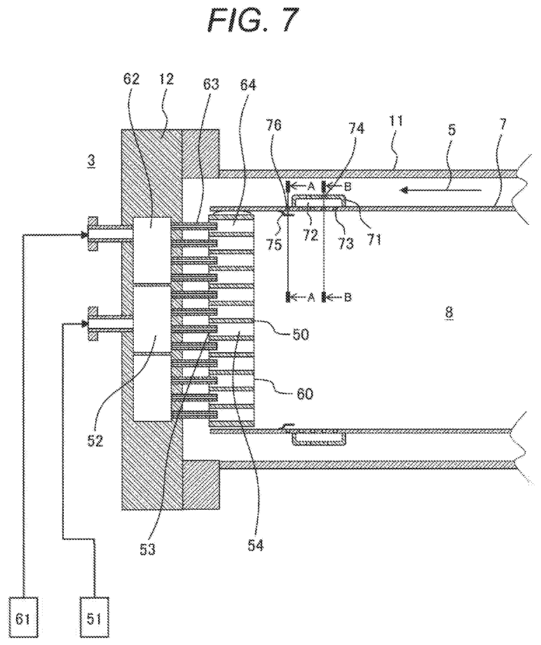

FIG. 7 illustrates a schematic partial structure of the combustor 3 according to the fifth example.

Unlike the combustor 3 according to the first example, the combustor 3 according to the fifth example is of multi-burner type having a pilot burner 50 and a plurality of main burners 60 upstream from the combustion chamber 8.

The pilot burner 50 receives supply of fuel from a pilot burner fuel supply system 51 via a fuel manifold 52 formed in the end cover 12. The fuel is spouted into air holes 54 formed in the pilot burner 50 through a fuel nozzle 53 connected to the fuel manifold 52. The compressed air 5 is supplied to the air holes 54 formed in the pilot burner 50. The fuel and the compressed air 5 are mixed inside the air hole 54 to generate a pilot flame downstream from the pilot burner 50.

The fuel is supplied to the main burners 60 from a main burner fuel supply system 61 via a fuel manifold 62 formed in the end cover 12. The fuel is spouted into air holes 64 formed in the main burner 60 from a fuel nozzle 63 connected to the fuel manifold 62. The compressed air 5 is supplied to the air holes 64 formed in the main burner 60. The fuel and the compressed air 5 are mixed inside the air hole 64 to generate a main flame downstream from the main burner 60.

The combustor 3 according to the fifth example disperses the fuel to be mixed with the compressed air 5. This makes it possible to accelerate the mixture at a shorter mixing distance, lower the concentration of discharged nitrogen oxides, and use the fuel such as hydrogen, which is burned at high speeds, and likely to cause a phenomenon of counter-current flow of the flame.

The combustion liner 7 of the combustor 3 according to the fifth example has the liner 71, the cooling air guide lip 75, the pressure dynamics damping holes 73, and the cooling hole 76. The liner 71 has an air hole 74.

On the occasion of pressure dynamics in the combustion chamber 8, the amplitude of the pressure dynamics is suppressed to attenuate the pressure fluctuation owing to the pressure dynamics. The cooling air guide lip 75 serves to form the circumferentially continuous uniform film-like airflow. The film-like airflow flows along the inner circumferential surface 7b of the combustion liner 7, and efficiently cools the inner circumferential surface 7b of the combustion liner 7 as well as the region where the pressure dynamics damping holes 73 are formed.

An explanation will be made with respect to the schematic partial structure of the combustor 3 according to the fifth example when it is seen from the combustion chamber 8.

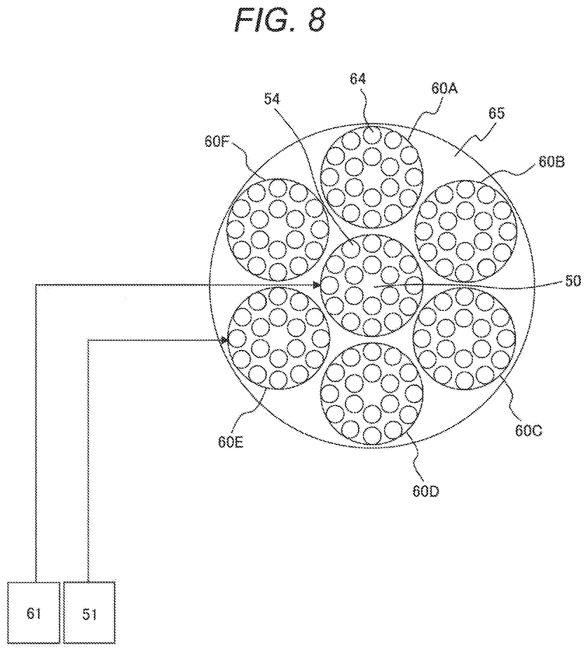

FIG. 8 illustrates a schematic partial structure of the combustor 3 according to the fifth example when it is seen from the combustion chamber 8.

The pilot burner 50 is disposed at the axial center of the combustor 3. Six main burners 60A, 60B, 60C, 60D, 60E, and 60F are arranged around the outer circumference of the pilot burner 50.

The pilot burner 50 has a plurality of air holes 54. Each of the six main burners 60A, 60B, 60C, 60D, 60E, and 60F has a plurality of air holes 64.

The premixture of the fuel spouting through the air holes 54 and the compressed air 5 generates the flame at a position downstream from the pilot burner 50. The premixture of the fuel spouting through the air holes 64 and the compressed air 5 generates the flame at positions downstream from the six main burners 60A, 60B, 60C, 60D, 60E, and 60F.

An explanation will be made with respect to the partially enlarged view of the main burners 60A and 60B of the combustor 3 according to the fifth example.

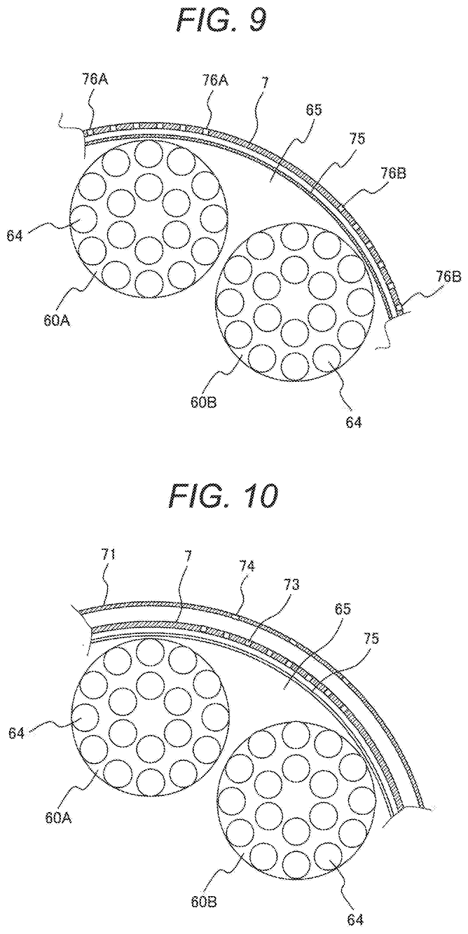

FIG. 9 is a sectional view of the combustor 3 according to the fifth example, taken along line A-A of FIG. 7.

The combustor 3 of multi-burner type is configured to generate the flame downstream from the main burners 60A and 60B adjacent thereto. The combustion liner 7 at the position corresponding to the part where the flame is generated may be brought into the high temperature state owing to the flame.

Meanwhile, as the flame is not generated in space 65 between the main burners 60A and 60B, the combustion liner 7 is hardly brought into the high-temperature state. However, there may be the case with less frequency that the combustion liner 7 is brought into the high-temperature state.

In the fifth example, the cooling holes 76 are formed in the combustion liner 7 at the positions corresponding to the respective parts where the flame is generated. In other words, a group of cooling holes 76A is formed at the position where the flame is generated by the main burner 60A, and a group of cooling holes 76B is formed at the position where the flame is generated by the main burner 60B.

From the group of cooling holes 76A, the compressed air 5 supplied to the gap between the cooling air guide lip 75 and the inner circumferential surface 7b of the combustion liner 7 diffuses circumferentially in the range where the flame is generated by the main burner 60A. From the group of cooling holes 76B, the compressed air 5 supplied to the gap between the cooling air guide lip 75 and the inner circumferential surface 7b of the combustion liner 7 diffuses circumferentially in the range where the flame is generated by the main burner 60B.

The position where the flame is formed by the main burner 60 (the region of the combustion liner 7, which is brought into the high temperature state) may be circumferentially displaced depending on a turn angle of the main burner 60. In the fifth example, the group of cooling holes 76 is formed at the position corresponding to the main burner 60 radially from the center for convenience of explanation. However, the position where the group of cooling holes 76 are formed may be circumferentially displaced.

Two lines tangent to one of the main burners 60 are drawn from the center of the combustion liner 7. Two points intersecting between the two tangential lines and the combustion liner 7 are set. Preferably, the group of cooling holes 76 is formed in the combustion liner 7 corresponding to the main burner 60 within the range between the two points.

The combustor 3 of multi-burner type according to the fifth example includes the pilot burner 50 at the axial center of the combustion chamber 8, as well as the main burners 60 arranged around the outer circumference of the pilot burner 50.

Like the first example, the combustor 3 includes the combustion liner 7 constituting the combustion chamber 8 for generating the combustion gas 9 using the supplied mixture of the fuel and the compressed air 5, and the liner 71 attached to the outer circumferential surface 7a of the combustion liner 7 for forming the space 72 from the outer circumferential surface 7a of the combustion liner 7. The combustor 3 also includes the pressure dynamics damping holes 73 formed in the combustion liner 7 provided with the liner 71 for communication between the space 72 and the combustion chamber 8.

Like the first example, the combustor 3 includes the cooling air guide lip 75 attached to the inner circumferential surface 7b of the combustion liner 7 for forming the film-like airflow 5d around the region where the pressure dynamics damping holes 73 are formed.

The combustor 3 according to the fifth example has the group of cooling holes 76 positioned corresponding to the part of the combustion liner 7, which is brought into the high temperature state by the flame generated by the main burner 60 for introducing the compressed air 5 to the gap formed between the cooling air guide lip 75 and the inner circumferential surface 7b of the combustion liner 7.

This makes it possible to efficiently cool the region of the combustion liner 7, which is brought into the high temperature state with a small air volume. According to the fifth example, the inner circumferential surface 7b of the combustion liner 7 may be efficiently cooled with a small air volume.

The film-like airflow 5d is formed around the region of the combustion liner 7 where the pressure dynamics damping holes 73 are formed to efficiently cool such region without increasing the concentration of discharged nitrogen oxides.

FIG. 10 is a sectional view of the combustor 3 according to the fifth example, taken along line B-B of FIG. 7.

The pressure dynamics damping holes 73 are formed in the combustion liner 7 at the position corresponding to the space 65 formed between the main burners 60A and 60B. In other words, the pressure dynamics damping holes 73 are formed in the combustion liner 7 at the position corresponding to the part between the main burners 60A and 60B.

In the fifth example, the pressure dynamics damping holes 73 are formed in the combustion liner 7 at the position corresponding to the space 65 formed between the main burners 60A and 60B, where the flame is hardly generated. The space 65 formed between the main burners 60A and 60B is at the position where the flame is hardly generated so that the combustion liner 7 is hardly brought into the high temperature state.

Two lines are drawn from the center of the combustion liner 7 to each center of the two main burners 60. Two points derived from intersection between the two lines and the combustion liner 7 are set. Preferably, the pressure dynamics damping holes 73 are formed in the combustion liner 7 at the position corresponding to the space 65 within a range between the two points.

Especially, the combustor 3 of multi-burner type is configured to generate the flame downstream from the main burner 60. The main burner 60 may impart the swirling component to the flame, resulting in the stabilized flame. According to the fifth example, even if the flame to which the swirling component is imparted flows around the inner circumferential surface 7b of the combustion liner 7, intrusion of the flame into the space 72 through the pressure dynamics damping holes 73 may be suppressed.

In the fifth example, the pressure fluctuation owing to the pressure dynamics may be attenuated. The pressure fluctuation owing to the pressure dynamics occurs in the combustion chamber 8. Therefore, even in the space 65 where the flame is hardly generated, the pressure fluctuation owing to the pressure dynamics will occur. In other words, even if the pressure dynamics damping holes 73 are formed in the combustion liner 7 at the position corresponding to the space 65, the pressure fluctuation owing to the pressure dynamics may be attenuated.

The air hole 74 is formed in the liner 71 at the position corresponding to the part where the pressure dynamics damping holes 73 are formed. In other words, the air hole 74 is formed in the liner 71 at the position corresponding to the space 65. This makes it possible to efficiently cool the region where the pressure dynamics damping holes 73 are formed.

Like the first example, in the fifth example, the cooling air guide lip 75 is attached to the inner circumferential surface 7b of the combustion liner 7 downstream from the liner 71 relative to the flow direction of the compressed air 5. However, the cooling air guide lip 75 may be attached to the inner circumferential surface 7b of the combustion liner 7 provided with the liner 71 around the region where the pressure dynamics damping holes 73 are formed similarly to the fourth example.

In the fifth example, the combustor is capable of efficiently cooling the inner circumferential surface 7b of the combustion liner 7 with a small air volume, reducing the flow rate of the compressed air 5 for cooling, and suppressing increase in the concentration of discharged nitrogen oxides. The mechanical reliability of the structure of the combustor 3 may be retained.

The present invention is not limited to the above-described examples, but includes various modifications. Specifically, the examples have been described in detail for readily understanding of the present invention. The present invention is not necessarily limited to the one provided with all structures as described above. It is possible to partially replace a structure of one of the examples with a structure of another example, or partially add the structure of one of the examples to the structure of another example. It is also possible to add, eliminate, and replace a part of the structure of one of the examples to, from, and with a part of the structure of another example.

### REFERENCE SIGNS LIST

1 . . . compressor,
2 . . . turbine,
3 . . . combustor,
4 . . . generator,
5 . . . compressed air,
6 . . . compressed air passage,
7 . . . combustion liner,
7a . . . inner circumferential surface,
7b . . . outer circumferential surface,
8 . . . combustion chamber,
9 . . . combustion gas,
10 . . . transition piece,
11 . . . combustion casing,
12 . . . end cover,
20 . . . diffusion burner,
21 . . . diffusion fuel supply system,
22 . . . fuel nozzle,
23 . . . swirler,
24 . . . diffusion fuel
25 . . . fuel jet hole,
30 . . . premix burner,
31 . . . premixed fuel supply system,
32 . . . fuel nozzle,
33 . . . premixed fuel,
34 . . . premixer,
35 . . . flame stabilizer,
50 . . . pilot burner,
51 . . . pilot burner fuel supply system,
52 . . . fuel manifold,
53 . . . fuel nozzle,
54 . . . air hole,
60 . . . main burner,
61 . . . main burner fuel supply system,
62 . . . fuel manifold,
63 . . . fuel nozzle
64 . . . air hole,
65 . . . space,
71 . . . liner,
72 . . . space,
73 . . . pressure dynamics damping hole,
74 . . . air hole,
75 . . . cooling air guide lip,
76 . . . cooling hole,

What is claimed is:

1. A gas turbine combustor including a combustion liner that forms a combustion chamber for receiving supply of fuel and air to generate combustion gas, a liner attached to an outer circumferential surface of the combustion liner for forming space from the outer circumferential surface, and a pressure dynamics damping hole formed in the combustion liner provided with the liner for communication between the space and the combustion chamber, the gas turbine combustor comprising a cooling air guide lip disposed on an inner circumferential surface of the combustion liner for forming a film-like airflow around a region where the pressure dynamics damping hole is formed.

2. The gas turbine combustor according to claim 1,
wherein a cooling hole for introducing the air into the combustion chamber is formed in the combustion liner downstream from the liner; and
the cooling air guide lip is disposed at a position corresponding to the cooling hole.

3. The gas turbine combustor according to claim 2,
wherein a cooling hole for introducing the air into the combustion chamber is formed in the combustion liner upstream from the liner; and
the cooling air guide lip is disposed at a position corresponding to the cooling hole.

4. The gas turbine combustor according to claim 1, wherein a rib is disposed on the outer circumferential surface of the combustion liner at a position at least upstream from the liner.

5. The gas turbine combustor according to claim 1, wherein the cooling air guide lip is disposed at a position corresponding to a region where the pressure dynamics damping hole is formed.

6. The gas turbine combustor according to claim 5, wherein the cooling air guide lip is disposed at a position corresponding to the pressure dynamics damping hole.

7. The gas turbine combustor according to claim 1, further comprising:
a diffusion burner for forming a diffusion flame by spouting diffusion fuel circulating through a fuel nozzle, and imparting a swirling component to air for combustion; and
a premix burner for forming a premixed flame using a mixture of premixed fuel spouting through the fuel nozzle and the air for combustion.

8. The gas turbine combustor according to claim 1, wherein the gas turbine combustor is of multi-burner type, including a pilot burner disposed at an axial center, and a plurality of main burners arranged around an outer circumference of the pilot burner.

9. The gas turbine combustor according to claim 8, wherein the combustion liner has a group of cooling holes at a position corresponding to a part where the flame is formed by the main burner.

10. The gas turbine combustor according to claim 8, wherein the combustion liner has the pressure dynamics damping hole at a position corresponding to a part between main burners adjacent to each other.
